(19) United States
(12) Patent Application Publication
(10) Pub. No.: US 2005/0151330 A1
(43) Pub. Date: Jul. 14, 2005

(54) Chuck comprising at least two clamping jaws

(75) Inventors: Thomas Huebl, Oppenweiler (DE); Achim Platzer, Backnang (DE)

Correspondence Address: AKERMAN SENTERFITT, P.O. BOX 3188, WEST PALM BEACH, FL, 33402-3188, US

(73) Assignee: Hainbuch GmbH Spannende Technik, Marbach (DE)

(21) Appl. No.: 10/514,000

(22) PCT Filed: May 5, 2003
(86) PCT No.: PCT/EP03/04804

(30) Foreign Application Priority Data
May 28, 2002 (DE) 10224367.0

(51) Int. Cl. B23B 31/16

(52) U.S. Cl. 279/110

(57) ABSTRACT

Disclosed is a chuck (11) that can be provided with three clamping jaws (13) which are guided in a non-torsional manner within inclined guiding members running at an angle from the longitudinal central axis. Said clamping jaws (13) are fixed to guiding means (19a) that are guided within the inclined guiding members (16, 17). The guiding means (19a) are configured as hollow cylinders and are provided with a connecting bar (22a), one end (23a) of which is connected to the hollow cylinder (19a) while the other end (24a) thereof is connected to a chuck piston (29), both ends (23a, 24a) being fixed in a rigid manner. The connecting bar (22a) is deformable or bendable in a radial direction such that said connecting bar (22a) can transmit power in a compensating manner from the chuck piston (29) to the guiding means (19a) and the clamping jaws (13) also during a relative movement thereof in a radial direction.

### FIELD OF APPLICATION AND PRIOR ART

The invention relates to a chuck according to the preamble of claim 1.

Such a chuck is known from G 86 15 459.1 where a chuck piston with a coupling ledge projecting in lug-like manner engages in coupling slots of the clamping jaws, a certain radial mobility existing. As a result of the movement of the chuck piston in the longitudinal direction the clamping jaw is also moved and runs radially inwards or outwards corresponding to the inclination of the clamping jaw guide. As a result the chuck is opened or, generally following the insertion of a tool, closed. The problem arises that such a sloping bolt chuck in part suffers from high wear. This particularly results from the relative movement and friction between the coupling ledge and the coupling slot. Since such chucks are mainly used due to their high rotational accuracy, wear leads to waste production in connection with the parts produced.

### PROBLEM AND SOLUTION

The problem of the invention is to provide an aforementioned chuck avoiding the disadvantages of the prior art and in particular enabling a reduction of friction and wear.

This problem is solved by a chuck having the features of claim 1. Advantageous and preferred developments of the invention form the subject matter of the further claims and are explained in greater detail hereinafter. The wording of the claims is, by express reference, made into part of the content of the description.

According to the invention the chuck has at least two and preferably three clamping jaws. The clamping jaws are non-rotatably guided in inclined guides of a chuck body, said inclined guides being inclined with respect to the median longitudinal axis of the chuck. A common chuck piston arranged in axially movable manner in the chuck body is provided for driving or moving the clamping jaws. The chuck piston is connected by connecting means to the clamping jaws and during an axial adjusting movement brings about an axial movement and simultaneously a radial movement of the jaws corresponding to the inclination of the inclined guides. The axial movement of the chuck piston and clamping jaws is preferably the same. The connecting means have a first connection point with the chuck piston and a second connection point with the clamping jaws. The term connection point is here understood to mean a connection area, e.g. with several points or in areal manner. The two connection points have a mutual axial spacing, which means that the connecting means have an extension in the axial direction. Thus, the clamping jaws and chuck pistons are axially spaced from one another. At least the connection points on which act the force bringing about the movement are axially spaced. This can be in certain areas of the chuck piston and/or clamping jaws, so that they are mutually axially spaced.

The advantage of elongated connecting means is that as a result the slope can be compensated in accordance with the inclination and in this way friction and relative movement with mutually engaging surface areas can be reduced. Moreover, and as will be indicated hereinafter, it is possible to reduce the friction by connecting means.

The connection points can also have a mutual radial spacing. It is advantageous if the first connection point between the connecting means and chuck pistons is radially closer to the median longitudinal axis of the chuck than the second connection point of connecting means and clamping jaws. Thus, the direction of the connecting means between the connection points can have an inclination similar to that of the inclined guides.

The connecting means can be elongated. In the longitudinal path thereof they are advantageously deformable so as to compensate force direction changes transmitted by the connecting means from the chuck piston to the clamping jaws for clamping movement. This force direction change is e.g. brought about in the known, above-described sloping bolt chuck by the relative movement and occurs with a high friction. However, according to the invention the force direction change can be absorbed in the connecting means.

In the case of a deformable construction, the connecting means can be formed by rigid members, which are not deformable and are interconnected by joints. The joints are in particularly advantageous manner constructed as simple swivel joints and are optimized with respect to the internal friction.

According to another deformable construction the connecting means can have bendability. This bendability advantageously occurs in a direction diverging from the longitudinal axis thereof. Advantageously bendability exists in the radial direction of the chuck. In particularly advantageous manner the connecting means are elastically deformable. It is in particular possible to construct the connecting means e.g. as a rod with a flat cross-section, which has the necessary bendability in the direction of the narrow cross-section.

Another deformable construction can be brought about in that the connecting means are bending-soft or bending-slack and it is particularly appropriate to use a wire rope or in general a traction cable.

It is possible to mount and fix the connecting means firmly and in particular in a stationary or rigid manner in the connection points to the chuck piston and to the clamping jaws, which reduces movements and therefore wear.

It is also possible to mount and fix the connecting means in movable or articulated manner in the connection points on the chuck piston and/or on the clamping jaws. This is advantageous with connecting means which are not constructed in deformable manner. Such a mounting can e.g. be constructed with spindles or alternatively with a ball and ball cup. It must be ensured that the mounting or bearing is optimized with regards to friction and wear.

According to another development of the invention, the inclined guides in which the clamping jaws are guided are elongated, the clamping jaws having elongated guiding means with which they are movably mounted in the inclined guides. The guiding means can be on the one hand separately constructed and connected to the clamping jaws. On the other hand they can also be integrally constructed with the clamping jaws. Advantageously the guiding means are constructed as elongated cylinders, particularly with a substantially identical cross-section.

In particular an area of the guiding means located at one end can be connected to the clamping jaws, especially in positive manner. Another area of the guiding means, particularly in the area or end area remote from the aforementioned area can be movably mounted in the inclined guides. The area mounted in the inclined guides should have a certain axial extension, e.g. approximately half the length of the guiding means. The area of the guiding means mounted in the inclined guides can be advantageously in the vicinity of the chuck piston.

It is possible to construct the guiding means as hollow cylinders, the connecting means running within said hollow cylinder. This brings about a reduction to the space required. For this purpose the inner area of the hollow cylinder must have adequate space for receiving the connecting means. Advantageously the inner area also permits the aforementioned deformability of the connecting means without the latter striking against the hollow cylinder. This prevents mechanical wear or even destruction.

The second connection point of the connecting means with the clamping jaws can advantageously be on the guiding means, which are once again connected in the vicinity with the clamping jaws. This allows an advantageously positive introduction of force from the connecting means, via the guiding means into the clamping jaws. The advantage is that in any case there is a connection between the clamping jaws and the guiding means.

In order to bring about a particularly secure, stable guidance of the clamping jaws, one end of the guide can project over said jaws and be mounted on a further guide. With respect to the inclination, said further guide can correspond to the previously described inclined guide. Thus, the elongated guiding means can be mounted at least in two end areas and therefore in a very stable and functionally secure manner.

It is possible to mount the chuck piston in a longitudinal guide running along the median longitudinal axis of the chuck body. It has a mechanical actuating device, for which purpose electromotive drives, as well as compressed air or hydraulic cylinders are suitable.

According to a further development of the invention the clamping jaws can have an adjusting area, which is mainly radially significant for the reception width of the chuck. The connecting means are advantageously constructed in such a way that in a position in which the clamping jaws are roughly in the centre of the adjusting range, they pass parallel or along the centre axis of the elongated, cylindrical guiding means. Particularly in the case of connecting means deformable by bendability this is a type of neutral position in which only tensile forces act in the connecting means. Thus, in both directions from said position can act further forces and consequently the latter do not become too high.

It is possible to have two guiding means for each clamping jaw, so that the clamping jaws can be very well guided. The guiding means can have a small lateral spacing from one another so as to make the arrangement space-saving.

Preferably there are three clamping jaws in the chuck body, particularly having the same mutual angular spacing. One clamping jaw can be a solid, integral jaw. Advantageously the clamping jaws have radially inner clamping inserts which can be replaced in the case of wear. However, in the sense of the present invention a clamping jaw on the one hand and clamping jaws with clamping inserts on the other are to be considered as equivalent.

It is therefore possible to create a chuck in which friction only occurs between the guiding means and the inclined guides and in particular there is no surface friction, except with ball cup bearings or journal bearings. Surface friction is largely avoided.

It is in particular possible to provide a connection between the chuck piston and clamping jaws without the piston directly engaging in said jaws. In particular a connection can be created without friction between two surfaces, which move substantially radially in engagement with one another. The term “radially” here means in particular an angle with respect to the median longitudinal axis of 60ø or higher.

These and further features can be gathered from the claims, description and drawings and the individual features, both singly or in the form of subcombinations, can be implemented in an embodiment of the invention and in other fields and can represent advantageous, independently protectable constructions for which protection is claimed here.

### BRIEF DESCRIPTION OF THE DRAWINGS

Embodiments of the invention are described in greater detail hereinafter relative to the drawings, wherein show:

FIG. 1A plan view of a chuck with guiding means, connecting bars and clamping jaws shown in section.

FIG. 2A lateral section through the chuck of FIG. 1 with the connecting bar.

FIG. 3A variant of the chuck of FIG. 2 with a connecting cable.

FIG. 4A further variant of the chuck of FIG. 2 with a rigid connecting bar mounted in articulated manner.

### DETAILED DESCRIPTION OF THE EMBODIMENTS

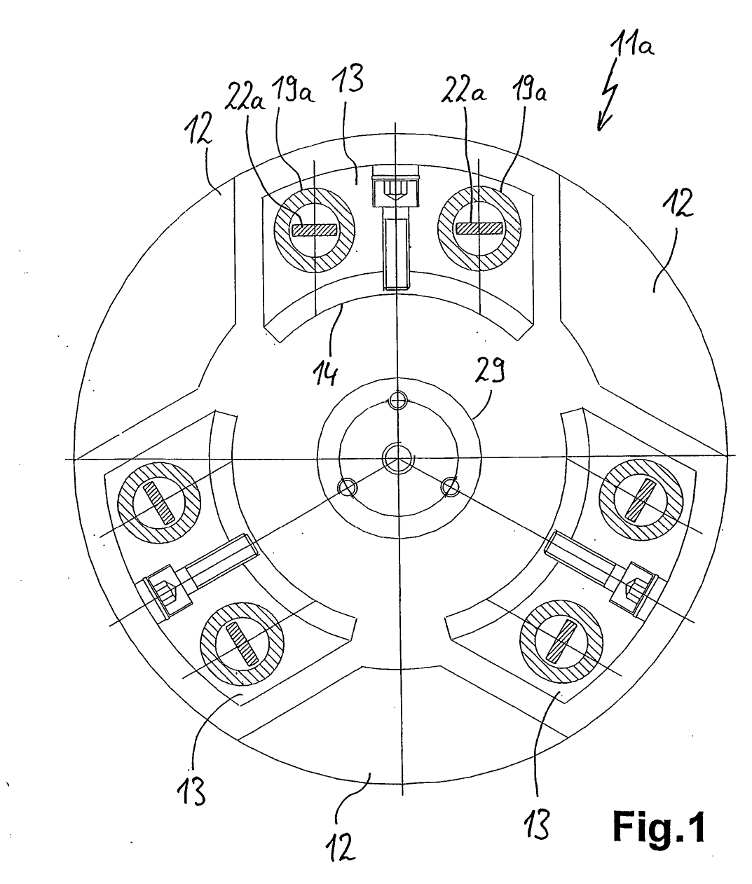

FIGS. 1 to 4 are to be understood essentially diagrammatically. The representations have in particular been chosen to illustrate the inventive principle on the basis of embodiments.

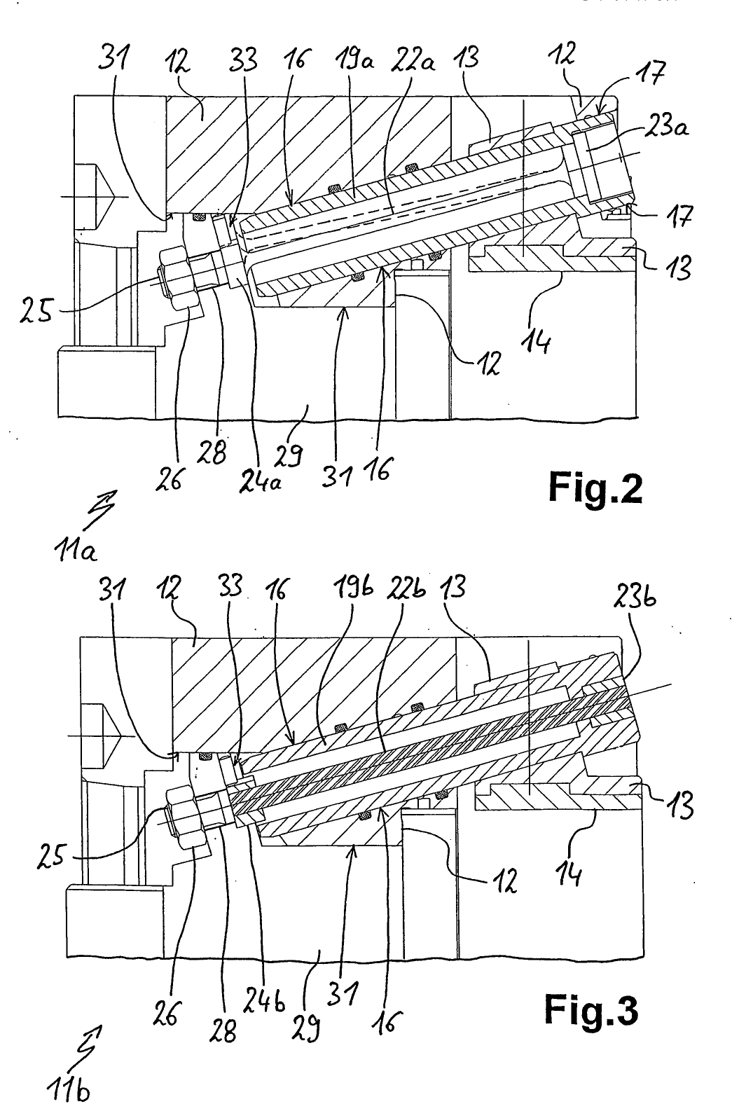

In FIGS. 1 and 2 a chuck 11 is shown in plan view with part section and in a lateral section. The chuck 11 has chuck walls 12, which are in particular integral components of the chuck. There are also clamping jaws 13 movable both axially and radially and bear on the radially inwardly directed side of the clamping inserts 14. FIG. 1 shows that there are three clamping jaws 13.

In the chuck walls 12 are constructed the inclined guides 16 with in FIG. 1 a second inclined guide 17 to the far right. The angle of the inclined guides 16, 17 with respect to the median longitudinal axis of the chuck 11 determines which movement of the clamping jaws 13 in the radial direction is performed with a specific adjustment in the axial direction. This angle more particularly determines the force transmission ratio between the axially directed adjusting force and the radially resulting clamping force. However, this is known to the expert and does not require further explanation here.

A guide cylinder 19a runs in the inclined guides 16, 17. The clamping jaw 13 in positively applied manner is mounted on the guide cylinder 19a. As is in particular apparent from FIG. 1 for each clamping jaw 13 there are two guide cylinders 19a. This permits a particularly precise, reliable guidance of the clamping jaws 13.

The connecting bar 22a runs within the guide cylinder 19a. The right-hand end 23a of the connecting bar 22a is positively inserted in the guide cylinder 19a. The left-hand end 24a of the connecting bar 22a has a screw thread 25, which is secured and fixed by means of a nut 26 in a receptacle 28 of a chuck piston 29. The ends 23a, 24a can also be fixed with a joint and ball and ball cup in the guide cylinder 19a and receptacle 28. As a result a shape change of the connecting bar 22a can be compensated in articulated manner. These joints can be specially constructed for receiving a pressure load and thereby preventing harmful wear.

The chuck piston 29 is axially movable along the median longitudinal axis in a longitudinal guide 31 of the chuck walls 12. For clamping or closing the chuck 11, the chuck piston 29 is moved to the left. By means of the nut 26 and the screw thread 25, it draws the connecting bar 22a to the left. The length-invariable connecting bar 22a as a result of its positive connection to the guide cylinder 19a brings about an axially directed movement to the left of said guide cylinder. The latter runs to the left in the inclined guides 16. It slides along the slope and moves radially inwards during the movement to the left. Therefore the clamping jaws 13 are moved radially inwards and the chuck 11 is clamped.

As is made clear by the broken line representation of the connecting bar 22a, the radial spacing of the left-hand end 24a of the connecting bar 22a with respect to the median longitudinal axis remains the same. However, as the guide cylinder 19a is moved closer to the median longitudinal axis, there is a relative movement between the connecting bar 22a and guide cylinder 19a into the broken line position, but there is no friction between them. However, this does not have an effect on the connection of the right-hand end 23a of the connecting bar 22a to the guide cylinder 19a or on the connection of the left-hand end 24a to the chuck position 29. Thus, at least in the represented direction, the connecting bar 22a is deformable and bendable. As a result of this deformability a relative movement otherwise causing disturbing friction can be avoided or replaced.

As shown, due to the striking of the connecting bar 22a against the radially outer inner edge of the guide cylinder 19a, said adjusting movement can only be performed in a certain range. However, this range is adequate. Otherwise the guide cylinder 19a can e.g. have a cutout.

As can be gathered from FIG. 1, the connecting bars 22a have a flat, rectangular cross-section. This leads to a deformability according to FIG. 2 in the radial direction, because here the cross-section is narrow. In addition, the stability of the connecting bar 22a against torsion and lateral movements is still maintained.

As can also be gathered from FIG. 1, the guide cylinder 19a is guided with its right-hand end on the second inclined guide 17 in the chuck walls 12 and also with the left-hand half in the inclined guide 16. Thus, friction concentrated in small areas and which is therefore harmful is avoided. Such a guidance is also very precise and ensures the stability and precision of the guidance of the clamping jaws 13.

A centring pin 33 is also provided and engages in a corresponding recess of the left-hand end 24a of the connecting bar 22a. It ensures that there is no twisting of the connecting bar 22a, particularly on tightening by means of nut 26.

As the clamping of the chuck 11 takes place by a movement to the left of the chuck piston 29 and therefore both the connecting bar 22a and the guide cylinder 1a and clamping jaws 13, the connecting bar 22a only transmits a tensile force. In order to release the chuck 11 again and move the clamping jaws 13 radially outwards, the chuck piston is moved to the right in the construction according to FIGS. 1 and 2. The connecting bar 22a then correspondingly presses the guide cylinder 19a and therefore also the clamping jaw, 13 to the right and radially outwards.

FIG. 3 shows a variant of a chuck 11b compared with the chuck 11a of FIG. 2. As is shown in FIG. 3, the chuck 11b has substantially the same construction, also with regards to the guide cylinder 19b and clamping jaw 13. The connecting bar 22a of FIG. 2 is replaced by the connecting cable 22b. The latter is advantageously in the form of a steel wire or strand and is only designed for the transmission of tensile forces.

The right-hand end 23b, e.g. in the form of a welded sleeve, of the connecting cable 22b is located in a correspondingly constructed, right-hand end of the guide cylinder 19b. Much as in FIG. 2, the left-hand end 24b has a thread 25, which is once again fixed with the nut 26 and consequently the connecting cable 22b is tensioned.

The connecting cable 22b is bending-slack and therefore deformable, much in the same way as the connecting bar 22a. The internal bending of both the connecting bar 22a and the connecting cable 22b essentially brings about no friction and only very limited material fatigue. However, material fatigue can be reduced or even completely avoided with a suitable material selection or construction of the connecting bar and connecting cable.

The chuck 11b is clamped or chucked in much the same way as chuck 11a, because the connecting cable 22b can also transmit a tensile force. The release of the chuck 11b must take place in a different way, because the connecting cable 22b cannot transmit a compressive force. The receptacle 28 of the chuck piston 29 is pressed against the left-hand face of the guide cylinder 19b, so that the latter is directly moved to the right. Admittedly between the receptacle 28 or chuck piston 29 and guide cylinder 19b a relative movement and friction which is to be avoided by the invention takes place. However, said movement is only very short. In particular, for releasing the chuck much lower forces over a much shorter area are required than for the clamping thereof.

FIG. 3 does not have the two inclined guides 17 of FIG. 2. This leads to a slightly reduced stability of the guide cylinder 19b in chuck 11b, but this is still adequate.

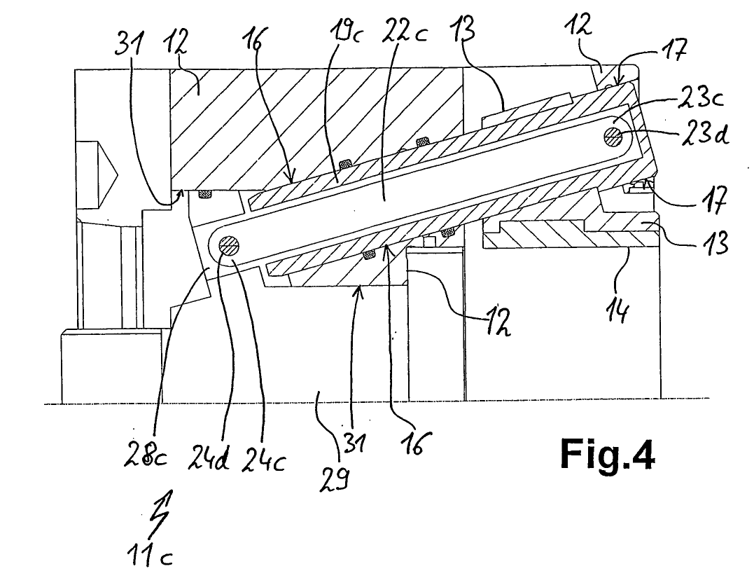

In the case of chuck 11b of FIG. 4 a connecting bar 22c is provided and is constructed as an articulated bar, which is rigid. The connection of the right-hand end 23c to the guide cylinder 19c takes place by means of a joint bolt 23d. The connection of the left-hand end 24c to the receptacle 28c of the chuck piston 29 takes place by means of a joint bolt 24d. Otherwise the structure of the chuck 11c is substantially the same as that of chuck 11a of FIG. 2.

In place of the deformability of the connecting bar 22a for chuck 11a of FIG. 2, the connecting bar 22c of chuck 11c can rotate about the joint bolts 23b and 24d during a movement to the left of chuck piston 29. Thus, with chuck 11c the adjusting force can be deflected in order to produce the clamping force. Admittedly here friction on the joint bolts 23b and 24d cannot be completely avoided. However, it is limited to the joint bolts or the bearing bushes receiving them. They can be constructed so as to avoid the otherwise harmful wear.

The joint bolts 23d and 24d can be positioned both on the connecting bar 22d and alternatively on the guide cylinder 19c and receptacle 28c. The reception bushes for the joint bolts are then constructed correspondingly.

Chuck 11c is opened in the same way as chuck 11a. The connecting bar 22c can be constructed for absorbing compressive forces.

1. Chuck with at least two clamping jaws, which are non-rotatably guided in the inclined guides of a chuck body sloping with respect to the median longitudinal axis and drivable by a common, axially movable chuck piston located in the chuck body, said chuck piston being connected by connecting means to the clamping jaws and in the case of an axial adjusting movement brings about an axial movement and simultaneously a radial movement of the clamping jaws corresponding to the slope of the inclined guides, characterized in that a first connection point of the connecting means has with the clamping piston an axial spacing with respect to a second connection point of the connecting means with the clamping jaws.

2. The chuck according to claim 1, characterized in that the connecting points are located in areas of the chuck piston and clamping jaws, which are axially remote from one another.

3. The chuck according to claim 1, characterized in that the first connection point of the connecting means with the chuck piston is radially closer to the median longitudinal axis of the chuck than the second connection point of the connecting means with the clamping jaws.

4. The chuck according to claim 1, characterized in that the connecting means are elongated and are preferably deformable in their longitudinal path for compensating force direction changes which they transmit from the chuck piston to the clamping jaws.

5. The chuck according to claim 4, characterized by a deformability of the connecting means by joints between rigid members, the rigid members connected by the joints forming the connecting means.

6. The chuck according to claim 4, characterized by a deformability of the connecting means through a bendability of the connecting means in a direction diverging from the longitudinal axis thereof, particularly in the radial direction of the chuck and preferably the connecting means are an elastically bendable bar.

7. The chuck according to claim 4, characterized in that the connecting means are constructed as a wire rope or a traction cable, particularly in bending-slack form.

8. The chuck according to claim 1, characterized in that the connecting means are mounted and fixed in secure and in particular stationary manner in connection points on the chuck piston and on the clamping jaws.

9. The chuck according to claim 1, characterized in that the connecting means are mounted and fixed in movable, preferably articulated manner in the connection points on the chuck piston and/or on the clamping jaws and preferably the connecting means are not deformable.

10. The chuck according to one of the preceding claim 1, characterized in that the inclined guides for the clamping jaws are elongated and the clamping jaws have elongated guiding means, the guiding means with the clamping jaws being movably mounted in the inclined guides and preferably the guiding means are elongated cylinders.

11. The chuck according to claim 10, characterized in that one end area of the guiding means is connected to the clamping jaws and the other end area of the guiding means is mounted in the inclined guide and preferably said end area is in the vicinity of the chuck piston.

12. The chuck according to claim 10, characterized in that the guiding means are constructed as hollow cylinders and the connecting means run within the hollow cylinder and preferably the inner area of the hollow cylinder has adequate space for the deformability of the connecting means without the same striking against the hollow cylinder as a result of a shape change or deformation.

13. The chuck according to claim 1, characterized in that the connecting means with the second connection point are fixed to the guiding means, which in the vicinity of the second connection point are connected to the clamping jaws and preferably said connection is constructed in positive manner in the direction of the first connection point.

14. The chuck according to claim 1, characterized in that one end of the guiding means projects over the clamping jaws and is guided in a further guide of the chuck body.

15. The chuck according to one of the preceding claim 1, characterized in that the clamping jaws have an adjusting area, the connecting means roughly in the position of the clamping jaws in the centre of the adjusting area run parallel or along the centre axis of the elongated, cylindrical guiding means.

16. The chuck according to one of the preceding claim 1, characterized in that the clamping jaws have two guiding means and preferably the latter are juxtaposed with a small lateral spacing.
